(19) United States
(12) Patent Application Publication
(10) Pub. No.: US 2019/0121163 A1
(43) Pub. Date: Apr. 25, 2019

(54) ADAPTIVE SPECTACLE LENS AND SPECTACLE LENS ASSEMBLY HAVING THE SAME

(71) Applicant: HON HAI PRECISION INDUSTRY CO., LTD., New Taipei (TW)

(72) Inventors: WEN-KAI LI, New Taipei (TW); HSIU-WEN CHIEN, New Taipei (TW)

(21) Appl. No.: 15/814,512

(22) Filed: Nov. 16, 2017

(30) Foreign Application Priority Data
Oct. 20, 2017 (CN) 201710984604.8

(51) Int. Cl. G02C 7/08; G02C 3/00

(52) U.S. Cl. CPC G02C 7/088; G02C 3/003

(57) ABSTRACT

An adaptive spectacle lens includes a spectacle frame and a pair of progressive additional lenses mounted to the spectacle frame. Each progressive additional lens includes a distant vision region positioned at an upper portion. The distant vision region has a diopter of zero and functions with a pair of main lenses.

### FIELD

The subject matter relates to spectacle lenses, and more particularly, to an adaptive spectacle lens and a spectacle lens assembly including the adaptive spectacle lens.

### BACKGROUND

Spectacle lenses are not only used for vision correction (such as nearsightedness, farsightedness, astigmatism, and presbyopia), but also used for eye protection and eye decoration. One person may use more than one spectacle lens in daily life. For example, for an elderly person who has both nearsightedness and presbyopia problems, the person may need a presbyopia spectacle lens to focus clearly on close objects, while distant objects appear blurry. The person may also need a nearsightedness spectacle lens to focus clearly on distant objects.

Frequently changing between different spectacle lenses is inconvenient. Customizing a spectacle lens involves a high cost. Improvements in the art are preferred.

### BRIEF DESCRIPTION OF THE DRAWINGS

Implementations of the present technology will now be described, by way of example only, with reference to the attached figures.

FIG. 1 is a diagram of an exemplary embodiment of a spectacle lens assembly including an adaptive spectacle lens, according to the present disclosure.

FIG. 2 is a cross-sectional view taken along line II-II of FIG. 1.

FIG. 3 is a diagram of an additional lens of the adaptive spectacle lens of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

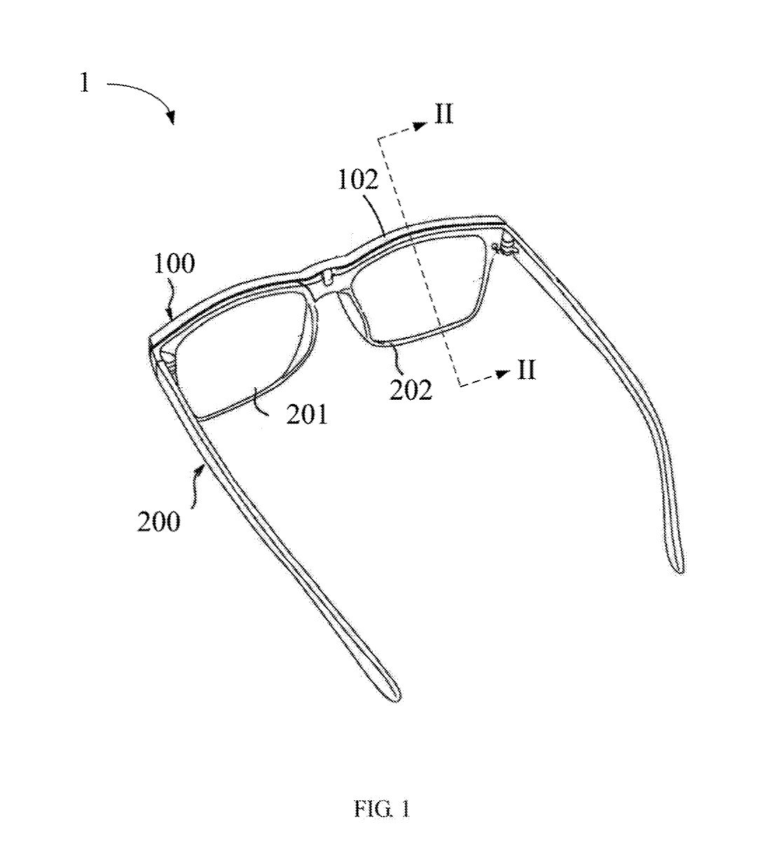

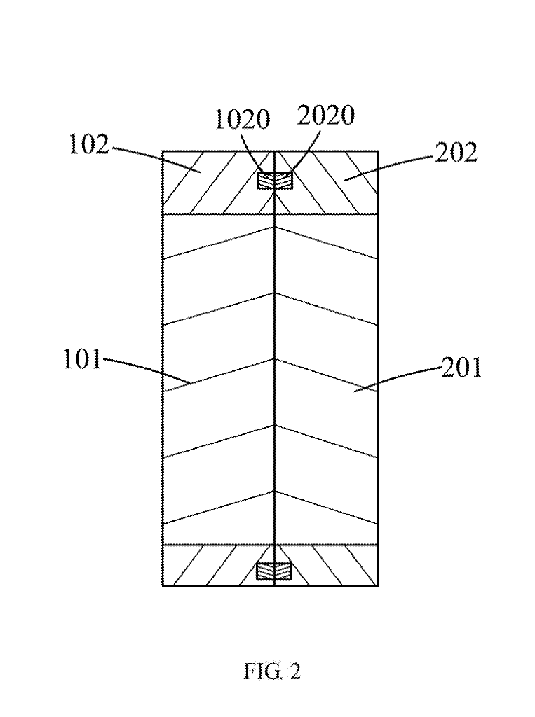

FIGS. 1 and 2 illustrate an exemplary embodiment of a spectacle lens assembly 1 comprising a main spectacle lens 200 and an adaptive spectacle lens 100.

The main spectacle lens 200 comprises a main spectacle frame 202 and a pair of main lenses 201 mounted to the main spectacle frame 202. In at least one exemplary embodiment, the main lenses 201 are nearsightedness lenses.

The adaptive spectacle lens 100 comprises a secondary spectacle frame 102 and a pair of additional lenses 101 (shown in FIG. 2) mounted to the secondary spectacle frame 102. In at least one exemplary embodiment, the additional lens 101 can be progressive additional lenses (PAL) made of cyclic block copolymer (CBC) by injection molding. The density of the CBC is less than 1 g/cm³, which allows the additional lenses 101 to have less weight.

In at least one exemplary embodiment, the secondary spectacle frame 102 can be removably connected to the main spectacle frame 202 by magnet, and can aesthetically match up with the main spectacle frame 202. Furthermore, the user can selectively combine the effects of the main lens 201 and the additional lens 101. In at least one embodiment, the main spectacle frame 202 defines a first groove (not label) at a surface facing the secondary spectacle frame 102. A first magnet 2020 is received in the first groove. Similarly, the secondary spectacle frame 102 defines a second groove (not label) at a surface facing the main spectacle frame 202. A second magnet 1020 is received in the second groove. The first magnet 2020 and the second magnet 1020 attract each other to connect the secondary spectacle frame 102 and the main spectacle frame 202. In another exemplary embodiment, the secondary spectacle frame 102 can also be removably connected to the main spectacle frame 202 by other mechanical fixing manner.

When the secondary spectacle frame 102 is connected to the main spectacle frame 202, the additional lenses 101 cover the main lenses 201, and a size and curve of outer surfaces of the main lenses 201 can match the inner surfaces of the additional lenses 101. Since the main lenses 201 would typically have a curvature of about 250 degrees (+2.50 D) to about 1000 degrees (+10.00 D), the additional lenses 101 should also have a curvature of about +2.50 D to about +10.00 D, thereby allowing the additional lenses 101 to substantially match the existing lenses in shape, including the lenses for indoor, outdoor, and special sports.

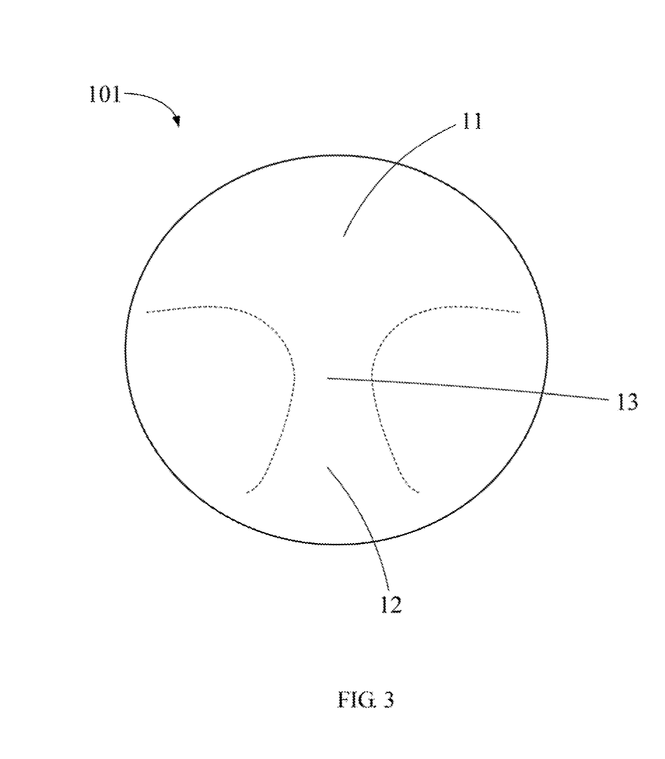

As shown in FIG. 3, each additional lens 101 comprises a distant vision region 11 positioned at an upper portion of the additional lens 101, a near vision region 12 positioned at a lower portion of the additional lens 101, and an intermediate vision region 13 between the distant vision region 101 and the near vision region 102. The distant vision region 11 has a diopter of zero. Thus, a portion of the main lenses 201 corresponding to the distant vision region 11 keeps its original diopter after combining with the additional lenses 101. The near vision region 12 can be used to correct vision at close viewing distance. The intermediate vision region 13 has gradually increases in dioptric power from the diopter of the distant vision region 11 to the diopter of the near vision region 12.

In at least one exemplary embodiment, the distant vision region 11 has a diopter of zero and the near vision region 12 has a diopter of about +0.75 D to about +2.50 D, the diopter of the near vision region 12 based on the patient's degree of presbyopia. Each of the distant vision region 11 and the near vision region 12 has a width of about 6 mm to about 20 mm, depending on conventional lens design parameters. The intermediate vision region 13 has a length of about 15 mm to about 25 mm, and a width of about 2 mm to about 7 mm, also depending on conventional lens design parameter.

An exemplary user can be an elderly person having both nearsightedness and presbyopia for example. If the lenses originally worn by the user (i.e., the main lenses 201) are nearsightedness lenses, close objects appear blurry. When the additional lenses 101 are combined with the main lenses 201, the user can clearly focus on close objects because the near vision region 12 can correct vision at close viewing distance. Furthermore, since the distant vision region 11 has a zero diopter, the combined diopter of the portion of the main lenses 201 corresponding to the distant vision region 11 and the distant vision region 11 remains the original diopter of the main lens 201. Accordingly, the user can still clearly focus on distant objects. Thus, the user has no need to frequently change between different spectacle lenses. The optical design of the additional lenses 101 allows the additional lenses 101 to be applied in combination with almost all kinds of main spectacle lenses, no matter the curvatures and diopters of the main spectacle lenses. Moreover, since the adaptive spectacle lens 100 can be combined with a general spectacle lens, a high cost caused by creating highly customized lens can be avoided.

In other exemplary embodiments, the main lenses 201 are not limited to nearsightedness lenses. For example, the main lenses 201 can also be astigmatism lenses.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. An adaptive spectacle lens comprising:
a secondary spectacle frame; and
a pair of additional lenses mounted to the secondary spectacle frame, each additional lens comprising a distant vision region positioned at an upper portion of the additional lens, and the distant vision region having a diopter of zero.

2. The adaptive spectacle lens of claim 1, wherein the pair of additional lenses are progressive additional lenses made of cyclic block copolymer (CBC) by injection molding.

3. The adaptive spectacle lens of claim 1, wherein the pair of additional lenses has a curvature of +2.50 D to +10.00 D.

4. The adaptive spectacle lens of claim 1, wherein each additional lens further comprises a near vision region positioned at a lower portion of the additional lens, and an intermediate vision region between the distant vision region and the near vision region.

5. The adaptive spectacle lens of claim 4, wherein the near vision region has a diopter of +0.75 D to +2.50 D.

6. The adaptive spectacle lens of claim 4, wherein each of the distant vision region and the near vision region has a width of about 6 mm to about 20 mm.

7. The adaptive spectacle lens of claim 4, wherein the intermediate vision region has a length of about 15 mm to about 25 mm, and a width of about 2 mm to about 7 mm.

8. A spectacle lens assembly comprising:
a main spectacle lens comprising:
a main spectacle frame; and
a pair of main lenses mounted to the main spectacle frame; and
an adaptive spectacle lens comprising:
a secondary spectacle frame connected to the main spectacle frame; and
a pair of additional lenses mounted to the secondary spectacle frame, the pair of additional lenses covering the pair of main lenses, each additional lens comprising a distant vision region positioned at an upper portion of the additional lens, and the distant vision region having a diopter of zero.

9. The spectacle lens assembly of claim 8, wherein the secondary spectacle frame is removably connected to the main spectacle frame to allow users to selectively combine effects of the main lens and the additional lens.

10. The spectacle lens assembly of claim 8, wherein the pair of additional lenses are progressive additional lenses made of cyclic block copolymer (CBC) by injection molding.

11. The spectacle lens assembly of claim 8, wherein the pair of additional lenses has a curvature of +2.50 D to +10.00 D.

12. The spectacle lens assembly of claim 8, wherein each additional lens further comprises a near vision region positioned at a lower portion of the additional lens, and an intermediate vision region between the distant vision region and the near vision region.

13. The spectacle lens assembly of claim 12, wherein the near vision region has a diopter of +0.75 D to +2.50 D.

14. The spectacle lens assembly of claim 12 wherein each of the distant vision region and the near vision region has a width of about 6 mm to about 20 mm.

15. The spectacle lens assembly of claim 12, wherein the intermediate vision region has a length of about 15 mm to about 25 mm, and a width of about 2 mm to about 7 mm.
